SEQUENCE LISTING (3 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus lentus
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNIQSTYPGSTYASLNGTSMATPHVAGAAALVKQKNPSWSNVQIRNHLKNTATSLGSTNLYGSGLVNAEAATR

SEQ ID NO: 3 - protein, 269 aa, Bacillus lentus
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGDGAISSIAQGLEWAGNNGMHVANLSLGSPSPSATLEQAVNSATSRGVLVVAASGNSGASSISYPARYANAMAVGATDQNNNRASFSQYGAGLDIVAPGVNIQSTYPGSTYASLNGTSMATPHVAGAAALVKQKNPSWSNVQIRNHLKNTATSLGSTNLYGSGLVNAEAATR

(19) United States
(12) Patent Application Publication
(10) Pub. No.: US 2017/0292086 A1
(43) Pub. Date: Oct. 12, 2017

(54) LIQUID SURFACTANT COMPOSITION HAVING SPECIAL SURFACTANT COMBINATION AND ENZYME

(71) Applicant: Henkel AG & Co. KGaA, Duesseldorf (DE)

(72) Inventors: Martina Seiler, Duisburg (DE); Dieter Nickel, Pulheim (DE); Sonja Sahner, Duesseldorf (DE); Christian Ramm, Duesseldorf (DE); Timothy O'Connell, Landsberg am Lech (DE)

(73) Assignee: Henkel AG & Co. KGaA, Duesseldorf (DE)

(21) Appl. No.: 15/626,088

(22) Filed: Jun. 17, 2017

Related U.S. Application Data
(63) Continuation of application No. PCT/EP2015/075794, filed on Nov. 5, 2015.

(30) Foreign Application Priority Data
Dec. 19, 2014 (DE) 10 2014 226 681.5

(51) Int. Cl. C11D 1/22; C11D 1/37

(52) U.S. Cl. CPC C11D 1/22; C11D 1/37

(57) ABSTRACT

Liquid surfactant compositions, containing, with respect to the total weight of the composition, a) a total amount of 2.0 to 8.5 wt. % C₉-C₂₀-alkylbenzene sulfonate, and b) a total amount of 10.0 to 18.0 wt. % R¹—O—(CH₂CH₂O)ₙ—SO₃M, wherein R¹ represents a C₁₂₋₁₈-alkyl group, n represents a number from 2 to 3, and M represents a monovalent cation, and c) a total amount of 1.0 to 6.0 wt. % R²—O—(CH₂CH₂O)ₘ—SO₃M′, wherein R² represents a C₁₂₋₁₈ alkyl group, m represents a number from 7 to 8, and M′ represents a monovalent cation, d) a total amount of 2.0 to 10.0 wt. % non-ionic surfactant, e) water, and f) at least one enzyme. The liquid surfactant compositions have an acceptable rheology for the user, are storage stable and ideal for stabilizing enzymes, such as proteases in particular.

### FIELD OF THE INVENTION

The present invention generally relates to the cleaning of textiles and to the provision of liquid compositions for this purpose.

### BACKGROUND OF THE INVENTION

Usually, liquid detergents are provided in an amount sufficient for multiple loads of laundry in storage containers. To carry out a washing process, the consumer removes the dose of liquid detergent required for one wash from this storage container. The required dose is typically ascertained by measuring the liquid detergent in a measuring cup and is subsequently transferred into a dosing dispenser drawer of a washing machine, for example, or added directly to the drum of the washing machine together with the measuring cup.

The liquid surfactant compositions suitable for liquid detergents should be easily dosable. For this purpose, the liquid surfactant compositions should have a suitable rheology. Compositions that are too low-viscous are perceived by the consumer as being more powerful. The response to this perception on the part of the consumer must not result in excessively viscous compositions, since otherwise complete emptying of the storage containers is insufficient.

The active substances present in the liquid surfactant composition, such as enzymes in particular, should moreover be incorporated in a storage-stable manner and preserve the activity over the storage time.

Accordingly, it is desirable to provide liquid surfactant compositions that exhibit acceptable rheology. In addition, it is desirable that the liquid surfactant compositions are storage stable without signs of phase separation or turbidity. It is also desirable that the liquid surfactant compositions are able to stabilize enzymes contained therein to maintain highly activity even after storage. Furthermore, other desirable features and characteristics of the present invention will become apparent from the subsequent detailed description of the invention and the appended claims, taken in conjunction with this background of the invention.

### BRIEF SUMMARY OF THE INVENTION

A first subject matter of the invention is a liquid surfactant composition, comprising, based on the total weight of the composition,
a) a total amount of 2.0 to 8.5 wt. % C₉-C₂₀ alkylbenzene sulfonate; and
b) a total amount of 10.0 to 18.0 wt. % R¹—O—(CH₂CH₂O)ₙ—SO₃M, in which R¹ denotes a C₁₂₋₁₈ alkyl group, n denotes a number from 2 to 3, and M denotes a univalent cation; and
c) a total amount of 1.0 to 6.0 wt. % R²—O—(CH₂CH₂O)ₘ—SO₃M′, in which R² denotes a C₁₂₋₁₈ alkyl group, m denotes a number from 7 to 8, and M′ denotes a univalent cation; and
d) a total amount of 2.0 to 10.0 wt. % non-ionic surfactant; and
e) water; and
f) at least one enzyme.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It was found that a composition, comprising alkylbenzene sulfonate anionic surfactants, a specific combination of ethoxylated alkyl sulfates, and non-ionic surfactant, each in specific quantities and quantity ratios, yields a liquid surfactant composition that has acceptable rheology and ensures the activity of the active substances incorporated therein, such as enzymes in particular, to an outstanding degree.

Published prior art CA 2 243 007 C describes liquid surfactant compositions that comprise 0.5 to 12 wt. % sodium carbonate and 5 to 35 wt. % of a surfactant mixture, each comprising, based on the total weight of the surfactant mixture,
i) 15 to 55 wt. %. of a compound of formula C₁₀₋₁₆-alkyl-O—(CH₂CH₂O)₃—SO₃M;
ii) 15 to 55 wt. %. of C₁₀₋₁₆-alkyl-O—(CH₂CH₂O)₇—SO₃M, 15 to 55 wt. %. of a compound of formula C₁₀₋₁₆-alkyl-O—(CH₂CH₂O)₃—H; and
iii) 15 to 55 wt. %. of a compound of formula C₁₀₋₁₆-alkyl-O—(CH₂CH₂O)₇—H, and
iv) 0.5 to 15 wt. % of an amphoteric surfactant.

Within the meaning of the invention, it shall generally be understood with respect to the definition of a number range that is to be “between” two range boundaries that the range boundaries are not included. Number ranges that are defined from one range boundary to another range boundary include the range boundaries.

All quantity information from a), b) and c) is calculated based on sodium as the counterion or univalent cation M and M′. If univalent cations M or M′ that are different from sodium are used, the amount by weight must thus be converted accordingly to sodium as the univalent cation.

The valence of univalent cations is 1.

The composition according to the invention is liquid at 25° C. and 1013 mbar.

It is essential that the surfactant composition according to the invention comprises 2.0 to 8.5 wt. % C₉-C₂₀ alkylbenzene sulfonate, preferably C₁₀-C₁₅ alkylbenzene sulfonate, and particularly preferably C₁₀-C₁₃ alkylbenzene sulfonate.

In the alkylbenzene sulfonate surfactants, “alkyl” preferably denotes a linear or branched unsubstituted alkyl radical. Such extremely preferred surfactants a) are selected from linear or branched alkylbenzene sulfonates of formula a

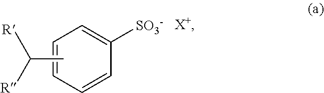

in which R′ and R″ together have 8 to 19, preferably 9 to 14, and in particular 9 to 12 carbon atoms, and X⁺ denotes a univalent cation, and in particular Na⁺, K⁺, HO—CH₂CH₂NH₃⁺, (HO—CH₂CH₂)₃NH⁺. An especially particularly preferred representative can be described by formula a-1:

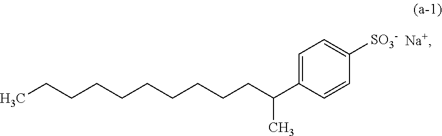

Most preferably, a total amount of 2.0 to 8.0 wt. % C₁₀-C₁₃ alkylbenzene sulfonate sodium salt is used. Still most preferably, a total amount of 2.0 to 8.0 wt. % C₁₂ alkylbenzene sulfonate sodium salt is used.

It is furthermore essential that the liquid surfactant composition according to the invention comprises a total amount of 10.0 to 18.0 wt. % R¹—O—(CH₂CH₂O)ₘ—SO₃M′, in which R¹ denotes a C₁₂₋₁₈ alkyl group, n denotes 2 or 3, and M denotes a univalent cation.

This is a C₁₂-C₁₈ alkyl sulfate comprising the univalent counterion M and 2 or 3 moles ethylene oxide per mole C₁₂-C₁₈ alkyl group.

Particularly preferably, n denotes 2.

Particularly preferably, M denotes Na⁺, K⁺, HO—CH₂CH₂NH₃⁺, (HO—CH₂CH₂)₃NH⁺, and especially particularly preferably Na⁺.

Most preferably, the liquid surfactant composition according to the invention comprises a total amount of 10.0 to 18.0 wt. % R¹—O—(CH₂CH₂O)₂—SO₃Na, in which R¹ denotes a C₁₂-C₁₈ alkyl group, and in particular dodecyl.

It is furthermore essential that the liquid surfactant composition according to the invention comprises a total amount of 1.0 to 6.0 wt. % R²—O—(CH₂CH₂O)ₘ—SO₃M′, in which R² denotes a C₁₂₋₁₈ alkyl group, m denotes 7 or 8, and M′ denotes a univalent cation. This is a C₁₂-C₁₈ alkyl sulfate comprising the univalent counterion M and 7 or 8 moles ethylene oxide per mole C₁₂-C₁₈ alkyl group.

Particularly preferably, m denotes 7.

Particularly preferably, M′ denotes Na⁺, K⁺, HO—CH₂CH₂NH₃⁺, (HO—CH₂CH₂CH₂)₃NH⁺, and especially particularly preferably Na⁺.

Most preferably, the liquid surfactant composition according to the invention comprises a total amount of 1.0 to 6.0 wt. % R²—O—(CH₂CH₂O)₇—SO₃Na, in which R² denotes a C₁₂-C₁₈ alkyl group, and in particular dodecyl.

For the cold washing performance, it has proven advantageous if the compositions additionally comprise soap(s) as the anionic surfactant. Soaps are the water-soluble sodium or potassium salts of saturated and unsaturated fatty acids having 10 to 20 carbon atoms, of the resin acids of colophony (yellow resinate) and of the naphthenic acids, which are used in the form of solid or semi-solid mixtures, primarily for washing and cleaning purposes. Sodium or potassium salts of saturated and unsaturated fatty acids having 10 to 20 carbon atoms, and in particular having 12 to 18 carbon atoms, are preferred soaps according to the invention. Particularly preferred compositions are characterized by comprising, based on the weight thereof; 0.1 to 15 wt. %, particularly preferably 0.2 to 12.0 wt. %, and especially particularly preferably 0.3 to 10.0 wt. % soap(s).

It is essential that the surfactant composition according to the invention comprises 2.0 to 10.0 wt. %, especially 2.5 to 7.5 wt. %, and more preferably 4.0 to 6.0 wt. % non-ionic surfactant.

It is particularly preferred that the compositions comprise at least one non-ionic surfactant from the group of the fatty alcohol ethoxylates since these surfactants also create compositions that are powerful at low washing temperatures, and exhibit excellent cold stability in the case of liquid preparations.

Preferred compositions thus additionally comprise at least one non-ionic surfactant of formula

R²—O-(AO)ₘ—H,

in which
R² denotes a linear or branched, substituted or unsubstituted alkyl, aryl or alkyl-aryl radical;
AO denotes an ethylene oxide (EO) or propylene oxide (PO) grouping;
m denotes integers from 1 to 50.

In the above-mentioned formula, R² denotes a linear or branched, substituted or unsubstituted alkyl aryl or alkyl-aryl radical, preferably a linear, unsubstituted alkyl radical, and particularly preferably a fatty alcohol group. Preferred groups R² are selected from decyl, undecyl, dodecyl, tridecyl, tetradecyl, pentadecyl, hexadecyl, heptadecyl, octadecyl, nonadecyl, eicosyl groups and the mixtures thereof wherein representatives having an even number of carbon atoms are preferred. Particularly preferred groups R² are derived from C₁₂ to C₁₈ fatty alcohols, for example from coconut fatty alcohol, tallow fatty alcohol, lauryl, myristyl, cetyl or stearyl alcohol, or from C₁₀ to C₂₀ oxo alcohols.

AO denotes an ethylene oxide (EO) or propylene oxide (PO) grouping, preferably an ethylene oxide grouping. The subscript m denotes an integer from 1 to 50, preferably from 1 to 20, and in particular from 2 to 10. It is especially particularly preferred if m denotes the numbers 2, 3, 4, 5, 6, 7, or 8.

In summary, particularly preferred surfactants are selected from fatty alcohol ethoxylates of formula C-1

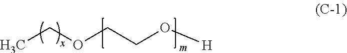

where k=11 to 19, m=2, 3, 4, 5, 6, 7 or 8. Especially particularly preferred representatives are C₁₂₋₁₈ fatty alcohols having 7 units of ethylene oxide (k=11 to 17, m==7 in formula C-1).

Especially particularly preferred compositions comprise 2.0 to 10 wt. %, especially 2.5 to 7.5 wt. %, and more preferably 4.0 to 6.0 wt. % fatty alcohol ethoxylate(s) (in particular of formula (C-1), again preferably where k=11 to 17, m=7) as the non-ionic surfactant, based on the total amount of the compositions.

It is preferred according to the invention if the weight ratio of surfactant component a) to surfactant component b) in the liquid surfactant composition according to the invention is 1:9 to 1:2, preferably 1:6 to 1:3, and particularly preferably 1:5 to 1:3.

It is preferred according to the invention if the weight ratio of surfactant component a) to surfactant component c) in the liquid surfactant composition according to the invention is 2:1 to 1:2, preferably 2:1 to 1:1, and particularly preferably 1.5:1 to 1:1.

It is preferred according to the invention if the weight ratio of surfactant component a) to surfactant component d) in the liquid surfactant composition according to the invention is 2:1 to 1:5, preferably 1.5:1 to 1:3, and particularly preferably 1:1 to 1:2.

Especially particularly preferred liquid surfactant compositions, based on the total weight of the composition, comprise
a) a total amount of 2.0 to 8.5 wt. % C₁₀-C₁₅ alkylbenzene sulfonate (and in particular C₁₀-C₁₃ alkylbenzene sulfonate sodium), and
b) a total amount of 10.0 to 18.0 wt. % R¹—O—(CH₂CH₂O)₂—SO₃M, in which R¹ denotes a C₁₂₋₁₈ alkyl group, and M denotes a univalent cation (in particular N⁺), and
c) a total amount of 1.0 to 6.0 wt. % R²—O—(CH₂CH₂O)₇—SO₃M′, in which R² denotes a C₁₂₋₁₈ alkyl group, and M′ denotes a univalent cation (in particular N⁺), and
d) a total amount of 2.0 to 10.0 wt. % fatty alcohol ethoxylate (in particular according to above formula (C-1), again preferably where k=11 to 17, m=7) as the non-ionic surfactant, and
e) water; and
f) at least one enzyme (in particular at least one protease, wherein again the proteases identified hereafter as being preferred are preferably suitable (vide infra)).
   It is again preferred to use one or more of the surfactant weight ratios a) to b), a) to c) or a) to d), each with respect to the present embodiment.

It is essential that the composition according to the invention comprises water as a solvent. It is preferred according to the invention to use water in a total amount of 20 to 80 wt. %, in particular of 30 to 70 wt. %, and especially particularly preferably of 40 to 60 wt. %, based on the weight of the composition.

In addition to the components that are essential according to the invention, organic solvents may be added to the liquid composition according to the invention. Organic solvents are liquid, dissolve at 20° C. to yield at least 1 g in 100 g distilled water, and include at least one covalent bond between the carbon and hydrogen in the molecule. It is essential according to the invention to use amino group-free organic solvents in a total amount of 0 to 10 wt. %, and in particular of 0 to 7.5 wt. %, based on the weight of the composition. Suitable amino group-free organic solvents comprise monohydric or polyhydric alcohols or glycol ethers, provided they are miscible with water in the indicated concentration range. The amino group-free organic solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxy butanol, propylene glycol t-butyl ether, di-n-octyl ether, and mixtures of two or more of the above-mentioned solvents. However, it is preferred that the composition according to the invention optionally comprises an amino group-free C₂ to C₄ alcohol comprising 1 to 3 hydroxyl groups, and in particular ethanol and/or glycerol and/or 1,2-propanediol.

It is essential that the composition according to the invention comprises at least one enzyme.

At the level of the proteins, “variant” is the term corresponding to “mutant” at the level of the nucleic acids. The predecessor or starting molecules can be the wild-type enzymes, which is to say those obtainable from natural sources. These may also be enzymes that already constitute variants per se, which is to say have already been modified compared to the wild-type molecules. These include point mutants, for example, those including modifications to the amino acid sequence, extended cohesive areas or cohesive areas across multiple positions, or hybrid molecules, which are composed of mutually complementary sections of different wild-type enzymes.

Amino acid exchanges shall be understood to mean substitutions of one amino acid with another amino acid. According to the invention, these substitutions are listed using the designation of the positions at which the exchange takes place, optionally combined with the particular amino acids in the internationally customary single letter code. An “exchange at position 320” means, for example, that a variant at the position that includes position 320 in the sequence of a reference protein comprises a different amino acid. Customarily, such exchanges at the DNA level are carried out via mutations of individual base pairs (see above). “R320K” means, for example, that the reference enzyme at position 320 comprises the amino acid arginine, while the considered variant at the position homologizable therewith includes the amino acid lysine. “320K” means that any arbitrary, which is to say in general a naturally predefined amino acid at a position that corresponds to position 320, is replaced with a lysine, which in the present molecule is situated at this very position. “R320K, L” means that the amino acid arginine at position 320 has been replaced with lysine or leucine. Additionally, “R320X” means that the amino acid arginine has been replaced with an essentially arbitrary other amino acid at position 320.

Generally, the amino acid exchanges according to the invention described by the present invention are not limited to being the only exchanges in terms of which the particular variant differs from the wild-type molecule. It is known in the prior art that the advantageous properties of individual point mutations can complement one another. Embodiments of the present invention thus cover all variants that, in addition to other exchanges compared to the wild-type molecule, also comprise the exchanges according to the invention.

Furthermore, in principle, the order in which the particular amino acid exchanges were carried out does not matter, which is to say whether a particular point mutant is further developed according to the invention, or whether initially a variant according to the invention is created from a wild-type molecule, for example, which is further developed in accordance with other teachings that can be found in the prior art. It is also possible to carry out multiple exchanges simultaneously in a mutagenesis approach, for example those according to the invention and others together.

It is preferred according to the invention if the enzyme present is at least one protease. A protease is an enzyme that cleaves peptide bonds by way of hydrolysis. According to the invention, this covers every enzyme from class EC.3.4 (comprising those of the thirteen subclasses covered thereby). The EC number corresponds to Enzyme Nomenclature 1992 from the NC-IUBMB, Academic Press, San Diego, Calif., including Supplements I to 5, published in Eur. J. Biochem. 1994, 223, 1-5; Eur. J. Biochem. 1995, 232, 1-6; Eur. J. Biochem. 1996, 237, 1-5; Eur. J. Biochem. 1997, 250, 1-6; and Eur. J. Biochem. 1999, 264, 610-650.

Subtilases are a group of serine proteases. Serine proteases or serine peptidases are a group of the proteases in which the serine in the active site of the enzyme forms a covalent adduct with the substrate. Furthermore, subtilases (and serine proteases) are characterized by comprising, in addition to the described serine, two additional amino acid residues in the active site, these being histidine and aspartame. The subtilases can be divided into 6 sub-classes, these being the subtilisin family, the thermitase family, the proteinase K family, the family of the lantibiotic peptidases, the kexin family, and the pyrrolysine family. The proteases preferably excluded as a component of the compositions according to the invention, or preferably present in reduced amounts, are endopeptidases (EC 3.4.21).

According to the invention, “protease activity” exists when the enzyme has proteolytic activity (EC 3.4). Various protease activity types are known. The three main types are: trypsin-like, wherein a cleavage of the amide substrate takes place after the amino acids Arg or Lys at P1; chymotrypsin-like, wherein a cleavage takes place after one of the hydrophobic amino acids at P1; and elastase-like, wherein a cleavage of the amide substrate takes place after Ala at P1.

The protease activity can be determined by the method described in Tenside, Vol. 7 (1970), pages 125-132. It is accordingly specified in PE (protease units). The protease activity of an enzyme can be according to customary standard methods, such as in particular using BSA as the substrate (bovine albumin), and/or using the AAPF method.

Surprisingly, it was found that a protease of the alkaline protease type from Bacillus lentus DSM 5483, or a protease that is sufficiently similar thereto (based on the sequence identity), comprising multiple of these modifications in combination, is particularly suitable for use in the liquid surfactant composition according to the invention, and is advantageously stabilized therein in an improved manner. Advantages of using this protease thus result in particular with respect to the washing performance and/or stability.

A particularly preferred embodiment of the invention is the described liquid surfactant composition, comprising, as the enzyme, at least one protease including an amino acid sequence that is at least 70% identical to the amino acid sequence indicated in SEQ ID NO. 1 over the entire length thereof and comprises the amino acid substitution R99E or R99D, using the numbering according to SEQ ID NO. 1, in combination with at least two further amino acid substitutions, which are selected from the group consisting of S3T, V4I, and V199I. This protease is described in document WO 2013060621, as is the method for producing this protease, comprising the introduction of an amino acid substitution R99E or R99D in combination with at least two further amino acid substitutions, which are selected from the group consisting of S3T, V4I and V199I, using the numbering according to SEQ ID NO. 1, into a starting protease that is at least 70% identical to the amino acid sequence indicated in SEQ ID NO. I over the entire length thereof

A preferred protease within the meaning of the present patent invention thus comprises both the protease per se, and a protease produced by way of a method according to the invention. All comments made with regard to the protease thus refer both to the protease as a substance and to corresponding methods, and in particular production methods of the protease.

As a further subject matter of the invention, liquid surfactant compositions, washing and cleaning methods comprising nucleic acids encoding these proteases, non-human host cells comprising proteases or nucleic acids according to the invention, and proteases according to the invention are associated with the preferred proteases according to the invention and the production methods for proteases according to the invention.

A modification according to the invention of position 99, which is to say a modification R99E or R99D, in conjunction with a modification to at least two of positions 3, 4 and 199, these being S3T, V4I or V199I, in a protease that comprises an amino acid sequence that is at least 70% identical to the amino acid sequence indicated in SEQ ID NO. 1, advantageously results in improved cleaning performance of this modified protease in washing and cleaning agents on at least one protease-sensitive stain. This applies to the liquid surfactant composition according to the invention, in particular when used at low temperatures of up to 10° C. Proteases according to the invention consequently allow improved removal of at least one, and preferably of multiple, protease-sensitive stains on textiles and/or hard surfaces, such as dishes. Particularly advantageous cleaning performance is exhibited by preferred embodiments of proteases according to the invention on stains containing blood, for example on blood stains on cotton: product no. 111, available from Eidgenössische Material-und Prüfanstalt (EMPA) Testmaterialien AG, St. Gallen, Switzerland; milk-soot on cotton (wfk—Cleaning Technology Institute e.V., Krefeld, Germany); and blood-milk/ink on cotton: product no. C-05 available from CFT (Center For Testmaterials) B.V. Viaardingen, the Netherlands.

Preferred embodiments of the described surfactant compositions comprising the described preferred soiling-specific protease achieve the advantageous cleaning performance at low temperatures between 10° C. and 60° C., between 15° C. and 50° C., and between 20° C. and 40° C. Consequently, particularly preferred embodiments of the described surfactant compositions comprising the described preferred soiling-specific protease are provided, having cleaning performance that is advantageous with respect to one stain, or with respect to multiple stains of a similar type, in particular at temperatures of no more than 25° C., and particularly preferably at temperatures of no more than 20° C. Consequently, the focus on stains of preferred embodiments of proteases according to the invention is improved with respect to blood-containing stains.

Furthermore, preferred embodiments of the proteases preferably used in the surfactant composition according to the invention exhibit particular stability in washing or cleaning agents, for example with respect to surfactants and/or bleaching agents and/or with respect to temperature influences, in particular with respect to high temperatures, for example between 50 and 65° C., and in particular 60° C., and/or with respect to acid or alkaline conditions and/or with respect to changes in the pH value and/or with respect to denaturing or oxidizing agents and/or with respect to proteolytic degradation and/or with respect to a change in the redox conditions. Such advantageous embodiments of proteases according to the invention consequently make improved washing results possible on protease-sensitive stains in a wide temperature range.

Cleaning performance within the scope of the invention shall be understood to mean the lightening performance on one or multiple stains, in particular on laundry or dishes. Within the scope of the invention, both the washing or cleaning agent that comprises the protease or the washing or cleaning liquor formed by this agent, and the protease itself exhibit a particular cleaning performance. The cleaning performance of the enzyme thus contributes to the cleaning performance of the agent, or of the washing or cleaning liquor formed by the agent. The cleaning performance is preferably ascertained as described hereafter.

The described protease that can preferably be used according to the invention also exhibits a proteolytic activity, which is to say it is capable of the hydrolysis of peptide bonds of a polypeptide or protein, in particular in a washing or cleaning agent. A preferred protease according to the invention is thus an enzyme that catalyzes the hydrolysis of peptide bonds, and thus is able to cleave peptides or proteins. Furthermore, the preferred protease according to the invention is preferably a mature protease, which is to say the catalytically active molecule having no signal peptide(s) and/or propetide(s). Unless indicated otherwise, the indicated sequences each also refer to mature enzymes.

In a further embodiment of the invention, the protease comprises an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%9, 98.5% and 98.8% identical to the amino acid sequence indicated in SEQ ID NO. 1 over the entire length thereof and comprises the amino acid substitution R99E, using the numbering according to SEQ ID NO. 1, in combination with at least two further amino acid substitutions, which are selected from the group consisting of S3T, V4I and V199I.

In a further embodiment of the invention, the protease comprises an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%8, 98.5% and 98.8% identical to the amino acid sequence indicated in SEQ ID NO. 1 over the entire length thereof and comprises the amino acid substitution R99D, using the numbering according to SEQ ID NO. 1, in combination with at least two further amino acid substitutions, which are selected from the group consisting of S3T, V4I and V199I.

Preferred proteases according to the invention are in particular:

Protease comprising an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identical to the amino acid sequence indicated in SEQ ID NO. I over the entire length thereof and comprises the amino acid substitution R99E, using the numbering according to SEQ ID NO. 1, in combination with the amino acid substitutions S3T and V4I, and in particular a protease according to SEQ ID NO. I comprising the amino acid substitutions S3T, V4I and R99E.

Protease comprising an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 925%, 93%, 93.5%, 94%, 94.5%, 95%, 95.5%, 96%, 96.5%, 97%, 97.5%, 98%, 98.5% and 98.8% identical to the amino acid sequence indicated in SEQ ID NO. I over the entire length thereof and comprises the amino acid substitution R99E, using the numbering according to SEQ ID NO. 1, in combination with the amino acid substitutions S3T and V199I, and in particular a protease according to SEQ ID NO. I comprising the amino acid substitutions S3T, R99E and V199I.

Protease comprising an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identical to the amino acid sequence indicated in SEQ ID NO. 1 over the entire length thereof and comprises the amino acid substitution R99E, using the numbering according to SEQ ID NO. 1, in combination with the amino acid substitutions V4I and V199I, and in particular a protease according to SEQ ID NO. 1 comprising the amino acid substitutions V4I, R99E and V199I.

Protease comprising an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identical to the amino acid sequence indicated in SEQ ID NO. 1 over the entire length thereof and comprises the amino acid substitution R99D, using the numbering according to SEQ ID NO. 1, in combination with the amino acid substitutions S3T and V4I, and in particular a protease according to SEQ ID NO. 1 comprising the amino acid substitutions S3T, V4I and R99D.

Protease comprising an amino acid sequence that is 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identical to the amino acid sequence indicated in SEQ ID NO. I over the entire length thereof and comprises the amino acid substitution R99D, using the numbering according to SEQ ID NO. 1, in combination with the amino acid substitutions S3T and V199I, and in particular a protease according to SEQ ID NO. I comprising the amino acid substitutions S3T, R99D and V199I.

Protease comprising an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identical to the amino acid sequence indicated in SEQ ID NO. 1 over the entire length thereof and comprises the amino acid substitution R99D, using the numbering according to SEQ ID NO. 1, in combination with the amino acid substitutions V4I and V199I, and in particular a protease according to SEQ ID NO. 1 comprising the amino acid substitutions V4I, R99D and V199I.

Further particularly preferred embodiments of proteases according to the invention are characterized by comprising the amino acid substitution R99E or R99D in combination with the three further amino acid substitutions S3T, V4I and V199I. In particular, the following proteases are especially particularly preferred in this regard:

Protease comprising an amino acid sequence that is at least 71%, 72%, 73%, 74%, 75%, 76%, 77%, 78%, 79%, 80%, 81%, 82%, 83%, 84%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, and 98.50% identical to the amino acid sequence indicated in SEQ ID NO. I over the entire length thereof and comprises the amino acid substitution R99E, using the numbering according to SEQ ID NO. 1, in combination with the amino acid substitutions S3T, V4I and V199I, and in particular a protease according to SEQ ID No. I comprising the amino acid substitutions S3T, V4I, R99E and V199I. Such a protease is indicated in SEQ ID NO. 2. The protease of SEQ ID NO. 2 is a protease that can be used especially particularly preferably in the surfactant composition according to the invention.

Protease comprising an amino acid sequence that is at least 71%, 72%, 73%, 74%, 75%, 76%, 770%, 78%, 79%, 80%, 81%, 82%, 83%, 84%, 85%, 86%, 87%, 88%, 89%, 90%, 90.5%, 91%, 91.5%, 92%, 92.5%, 930%, 93.5%, 94%, 94.5%, 95%, 95.50%, 96%, 96.5%, 97%, 97.5%, 98%, and 98.5% identical to the amino acid sequence indicated in SEQ ID NO. 1 over the entire length thereof and comprises the amino acid substitution R99D, using the numbering according to SEQ ID NO. 1, in combination with the amino acid substitutions S3T, V4I and V199I, and in particular a protease according to SEQ ID No. 1 comprising the amino acid substitutions S3T, V4I, R99D and V199I. Such a protease is indicated in SEQ ID NO. 3.

Further particularly preferred proteases are proteases as described above, which furthermore at position 211, using the numbering according to SEQ ID NO. 1, comprise the amino acid leucine (L).

The identity of nucleic acid or amino acid sequences is determined by a sequence comparison. This sequence comparison is based on the BLAST algorithm that is established in the prior art and customarily used (see, for example, Altschul, S. F., Gish, W., Miller, W., Myers, E. W. & Lipman, D. J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, pgs. 3389-3402) and is essentially carried out by assigning similar successions of nucleotides or amino acids in the nucleic acid sequences or amino acid sequences to each other. A tabular assignment of the particular positions is referred to as an alignment. Another algorithm available in the prior art is the FASTA algorithm. Sequence comparisons (alignments), in particular multiple sequence comparisons, are created using computer programs. For example, the Clustal series (see, for example, Chenna et al. (2003): Multiple sequence alignment with the Clustal series of programs. Nucleic Acid Research 31, 3497-3500), T-Coffee (see, for example, Notredame et al. (2000): T-Coffee: A novel method for multiple sequence alignments. J. Mol. Biol. 302, 205-217) or programs that are based on these programs or algorithms are frequently used. In the present patent invention, all sequence comparisons (alignments) were carried out with the computer program Vector NTI® Suite 10.3 (Invitrogen Corporation, 1600 Faraday Avenue, Carlsbad, Calif., USA) using the predefined standard parameters, the AlignX module of which for the sequence comparisons is based on ClustalW.

Such a comparison also allows information to be provided about the similarity of the compared sequences among each other. It is customarily indicated in percent identity, which is to say the proportion of identical nucleotides or amino acid residues at the same positions or at positions corresponding to each other in an alignment. The broader concept of homology, in the case of amino acid sequences, takes conserved amino acid exchanges into consideration, which is to say amino acids having similar chemical activity, since these generally carry out similar chemical activities within the protein. The similarity of the compared sequences may thus also be indicated in percent homology or percent similarity. Identity and/or homology information can be provided for entire polypeptides or genes, or only for individual regions. Homologous or identical regions of different nucleic acid or amino acid sequences are therefore defined by agreement in the sequences. Such regions often have identical functions. They may be small and comprise only few nucleotides or amino acids. Such small regions often carry out functions that are essential for the overall activity of the protein. It may therefore be useful to relate sequence agreements only to individual, optionally small regions. Unless indicated otherwise, however, identity or homology information in the present application refers to the entire length of the respective indicated nucleic acid or amino acid sequence.

In an especially particularly preferred embodiment of the invention, the protease is characterized in that the cleaning performance thereof corresponds at least to that of a protease which comprises an amino acid sequence that corresponds to the amino acid sequence indicated in SEQ ID NO. 2, and/or at least to that of a protease which comprises an amino acid sequence that corresponds to the amino acid sequence indicated in SEQ ID NO. 3, wherein the cleaning performance is determined in a washing system containing a washing agent in a dose between 4.5 and 7.0 grams per liter of washing liquor and the protease, wherein the proteases to be compared are used in the same concentrations (based on active protein), and the cleaning performance with respect to a blood stain on cotton, and in particular with respect to the blood stain on cotton: product no. 111 available from Eidgenössische Material-und Prüfanstalt (EMPA) Testmaterialien AG, St. Gallen, Switzerland, is determined by measuring the whiteness of the laundered textiles, the washing process is carried out for 70 minutes at a temperature of 40° C., and the water has a hardness between 15.5 and 16.5° (general hardness). The concentration of the protease in the washing agent intended for this washing system is 0.001 to 0.1 wt. %, and preferably 0.01 to 0.06 wt. %, based on active protein.

The liquid surfactant compositions according to the invention comprise (preferably in addition to the protease) at least one enzyme selected from α-amylase, cellulase, mannanase, lipase, and pectate lyase as an enzyme.

In general, the enzymes present in a composition according to the invention can be adsorbed on carrier materials and/or be embedded in coating substances so as to protect them against premature inactivation.

The obtained enzymes can be added to the compositions according to the invention in any form established in the state of the art. This includes, in particular, the solid preparations obtained by way of granulation, extrusion or lyophilization, which advantageously are preferably concentrated, low-hydrate and/or mixed with stabilizers. In an alternative packaging form, the enzymes can also be encapsulated, for example by spray drying or extruding the enzyme solution together with a preferably natural polymer, or in the form of capsules, for example those in which the enzymes are enclosed as in a solidified gel, or in those of the core-shell type, in which an enzyme-containing core is coated with a protective layer impervious to water, air and/or chemicals. Further active ingredients, such as stabilizers, emulsifiers, pigments, bleaching agents or dyes can additionally be applied in superimposed layers. Such capsules are applied using methods that are known per se, for example agitation or roll granulation or in fluid bed processes. Such granules are advantageously low-dust, for example by applying polymeric film formers, and storage-stable due to the coating.

The liquid surfactant compositions in addition preferably comprise at least one cellulase. A cellulase is an enzyme. Synonymous terms can be used for cellulases, in particular endoglucanase, endo-1,4-beta-glucanase, carboxymethyl cellulase, endo-1,4-beta-D-glucanase, beta-1,4-glucanase, beta-1,4-endoglucan hydrolase, celludextrinase or avicelase. The decisive factor as to whether an enzyme is a cellulase within the meaning of the invention is the capability thereof to carry out the hydrolysis of 1,4-β-D-glucosidic linkages in cellulose.

Cellulases that can be formulated according to the invention (endoglucanases, EG) encompass, for example, the fungal, endoglucanase (EG)-rich cellulase preparation or the further developments thereof, which are offered by Novozymes under the trade name Celluzyme®. The products Endolase® and Carezyme® likewise available from Novozymes are based on the 50 kD EG and 43 kD EG, respectively, from Humicola insolens DSM 1800. Further commercial products of this company that may be used are Cellusoft®, Renozyme® and Celluclean®. Furthermore, for example, it is possible to use cellulases that are available from AB Enzymes, Finland, under the trade names Ecostone® and Biotouch®, which are at least partially based on the 20 kD EG from Melanocarpus. Further cellulases from AB Enzymes are Econase® and Ecopulp®. Further suitable cellulases are derived from Bacillus sp. CBS 670.93 and CBS 669.93, wherein that from Bacillus sp. CBS 670.93 is available from Danisco/Genencor under the trade name Puradax®. Further commercial products of Danisco/Genencor that may be used are “Genencor detergent cellulase L” and IndiAge® Neutra.

According to the invention, it is also possible to use variants of these enzymes obtained by way of point mutations. Particularly preferred cellulases are Thielavia terrestris cellulase variants, which are disclosed in the international unexamined patent application WO 9812307, cellulases from Melanocarpus, and in particular Melanocarpus albomyces, which are disclosed in the international unexamined patent application WO 9714804, cellulases of the EGIII type from Trichoderma reesei, which are disclosed in the European patent application EP 1305432, or variants obtainable therefrom, in particular those that are disclosed in the European patent applications EP 1240525 and EP 1305432, and cellulases that are disclosed in the international unexamined patent applications WO 1992006165, WO 9629397 and WO 02099091. Express reference is thus made to the respective disclosure of these documents, or the disclosure thereof in this regard is thus expressly incorporated in the present patent invention by reference.

Particularly preferred compositions according to the invention are characterized in that the additional cellulase is at least one cellulase from Melanocarpus sp. or 20K cellulase derivable from Myriococcum sp., or such showing homology of more than 80% (increasingly preferably more than 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99.0%, 99.1%, 99.2%, 99.3%, 99.4%, 99.5%, 99.6%, 99.7%, 99.8%, 99.9%).

The 20K cellulase obtainable from Melanocarpus sp. or Myriococcum sp. is known from the international patent application WO 9714804. As described there, the cellulase has a molecular weight of approximately 20 kDa and it has at least 80% of the maximum activity thereof at 50° C. in a pH range of 4 to 9, wherein almost 50% of the maximum activity is retained at pH 10. As is likewise described, it may be isolated from Melanocarpus albomyces and produced in Trichoderma reseei transformants by way of genetic engineering. Within the meaning of the present invention, it is also possible to use cellulases that show homology of more than 80% (increasingly preferably more than 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99.0%, 99.1%, 99.2%, 99.3%, 99.4%, 99.5%, 99.6%, 99.7%, 99.8%, 99.9%) toward 20K cellulase.

K20 cellulase is preferably used in such amounts that a composition according to the invention has a cellulolytic activity of 1 NCU/g to 500 NCU/g (determinable by the hydrolysis of 1% by weight carboxymethyl cellulose at 50° C. and neutral pH and determination of the reducing sugars released in the process by way of dinitrosalicylic acid, as described by M. J. Bailey et al. in Enzyme Microb. Technol. 3: 153 (1981). 1 NCU defines the amount of enzyme that produces reducing sugar in an amount corresponding to 1 nmol glucose per second), in particular of 2 NCU/g to 400 NCU/g, and particularly preferably of 6 NCU/g to 200 NCU/g. In addition, the composition according to the invention may optionally comprise further cellulases.

A composition according to the invention preferably comprises 0.001 mg to 0.5 mg, and in particular 0.02 to 0.3 mg of cellulolytic protein per gram of the entire composition. The protein concentration can be determined with the aid of known methods, such as the bicinchoninic acid method (BCA method, Pierce Chemical Co., Rockford, Ill.) or the Biuret method (A. G. Gornall, C S. Bardawill und M. M. David, J. Biol. Chem. 177, 751-766, 1948).

It is again particularly preferred according to the invention to use, in addition to at least one first cellulase from Melanocarpus sp. or 20K cellulase derivable from Myriococcum sp., or such showing homology of more than 80% (increasingly preferably more than 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99.0%, 99.1%, 99.2%, 99.3%, 99.4%, 99.5%, 99.6%, 99.7%, 99.8%, 99.9%), at least one further second cellulase different from the first cellulase.

Is preferred according to the invention if the liquid surfactant compositions according to the invention additionally comprise at least one lipase. Preferred lipase enzymes according to the invention are selected from at least one enzyme of the group consisting of triacylglycerol lipase (EC 3.1.1.3), lipoprotein lipase (EC 3.1.1.34) and monoglyceride lipase (EC 3.1.1.23).

The preferred field of application according to the invention of the compositions according to the invention is the cleaning of textiles. Since washing and cleaning agents for textiles primarily have alkaline pH values, in particular lipases that are active in the alkaline environment are used for this purpose.

Furthermore, the lipase that is preferably present in a composition according to the invention is present naturally in a microorganism of the Thermomyces lanuginosus or Rhizopuss oryzae or Mucor javanicus species, or derived from the aforementioned naturally occurring lipases by way of mutagenesis. It is particularly preferred if the compositions according to the invention comprise at least one lipase that is naturally present in a microorganism of the Thermomyces lanuginosus species, or derives from the aforementioned lipases occurring naturally in Thermomyces lanuginosus by way of mutagenesis.

Naturally occurring in the present context shall mean that the lipase is an inherent enzyme of the microorganism. The lipase can consequently be expressed in the microorganism by a nucleic acid sequence that forms part of the chromosomal DNA of the microorganism in the wild-type form thereof. This lipase, or the nucleic acid sequence encoding the same, is consequently present in the wild-type form of the microorganism and/or can be isolated from the wild-type form of the microorganism. In contrast, a lipase not naturally occurring in the microorganism, or the nucleic acid sequence encoding the same, would have deliberately been introduced into the microorganism by way of genetic engineering methods, so that the microorganism would have been enhanced with the lipase or the nucleic acid sequence encoding the same. However, a lipase that occurs naturally in a microorganism of the Thermomyces lanuginosus or Rhizopus oryzae or Mucor javanicus species can certainly also have been recombinantly produced from another organism.

The Thermomyces lanuginosus fungus (also known as Humicola lanuginosa) is part of the class of the Eurotiomycetes (subclass: Eurotiomycetidae), therein of the order of the Eurotiales, and therein of the Trichocomaceae family and the Thermomyces genus. The Rhizopus oryzae fungus is part of the class of the Zygomycetes (subclass: Incertae sedis), therein of the order of the Mucorales, and therein, in turn, of the Mucoraceae family and the Rhizopus genus. The Mucor javanicus fungus is likewise part of the class of the Zygomycetes (subclass: Incertae sedis), therein of the order of the Mucorales, and therein, in turn, of the Mucoraceae family, and therein of the Mucor genus. The designations Thermomyces lanuginosus, Rhizopus oryzae and Mucor javarnicus are the biological terms of the species within the particular genus.

Preferred lipases according to the invention are the lipase enzymes available from Amano Pharmaceuticals under the designations Lipase M-AP10®, Lipase LE®, and Lipase F® (or Lipase JV®). The Lipase F®, for example, occurs naturally in Rhizopus oryzae. The Lipase M-AP10®, for example, occurs naturally in Mucor javanicus.

Compositions of an especially particularly preferred embodiment of the invention comprise at least one lipase selected from at least one or more polypeptides comprising an amino acid sequence that is at least 90% (and increasingly preferably at least 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99.0%, 99.1%, 99.2%, 99.3%, 99.4%, 99.5%, 99.6%, 99.7%, 99.8%, 99.9%) identical to the wild type lipase from the strain DSM 4109 Thermomyces lanuginosus. It is again preferred if proceeding from the described wild type lipase from the strain DSM 4109, at least one amino acid modification N233R is present.

Within the scope of a further embodiment, in particular lipases derived from the wild-type lipase from the strain DMS 4109, which are selected from at least one lipase enzyme according to at least one of claims 1 to 13 of document WO 0060063 A1, can preferably be used according to the invention. The entire disclosure of document WO 0060063 A1 is hereby incorporated by reference.

It is particularly preferred if at least one lipase is used in the compositions according to the invention, which is derived from the wild type lipase from the strain DMS 4109 and in which, proceeding from the described wild type lipase, at least one substitution of an electrically neutral or negatively charged amino acid with a positively charged amino acid has taken place. The charge is determined in water at pH 10. Negative amino acids within the meaning of the invention are E, D, Y and C. Positively charged amino acids within the meaning of the invention are R, K and H, in particular R and K. Neutral amino acids within the meaning of the invention are G, A, V, L, I, P, F, W, S, T, M, N, Q and C, if C forms a disulfide bond.

Within the scope of the present embodiment of the invention, it is again preferred if, proceeding from the wild type lipase from the strain DMS 4109, at least one of the following amino acid exchanges is present at positions D96L, T213R and/or N233R, and particularly preferably T213R and N233R.

A most preferred lipase can be procured commercially from Novozymes (Denmark) under the trade name Lipex® and can advantageously be used in the cleaning compositions according to the invention. The lipase Lipex® 100 L (Novozymes A/S, Denmark) is particularly preferred. Preferred compositions are characterized in that the described lipase enzyme of Lipex® 100 L is present in a total amount of 0.01 to 1.0 wt. %, and in particular of 0.02 to 0.1 wt. %, based on the total weight of the composition.

The compositions according to the invention can additionally comprise at least one mannanase as the enzyme. A mannanase present in the compositions according to the invention (in particular in a preferred washing and cleaning agent according to the invention for textiles) catalyzes the hydrolysis of 1,4-beta-D-mannosidic bonds in mannans, galactomanns, glucomanns and galactoglucomanns as part of the mannanase activity thereof. The described mannanase enzymes according to the invention are classified according to Enzyme Nomenclature as EC 3.2.1.78.

The mannanase activity of a polypeptide or enzyme can be determined according to test methods known from the literature. For example, a test solution is introduced into wells of an agar plate having a diameter of 4 mm, containing 0.2 wt. % AZCL Galactomannan (carob), which is to say the substrate for the endo-1,4-beta-D-mannanase assay, available from Megazyme (http://www.megazyme.com) under catalog number 1-AZGMA.

Suitable compositions according to the invention, for example, comprise the mannanase sold by Novozymes under the name Mannaway®.

Mannanase enzymes have been identified in numerous Bacillus organisms.

WO 9964619 discloses examples of liquid, protease-containing washing agent compositions having a high overall surfactant content of at least 20 wt. %, which additionally comprise mannanase enzyme.

It is preferred if the compositions according to the invention comprise mannanase in a total amount of 0.01 to 1.0 wt. %, and in particular of 0.02 to 0.1 wt., based on the total weight of the composition.

Mannanase polypeptides from strains of the Thermoanaerobacter group, such as Caldicellulosiruptor, are preferably suited according to the invention. Mannanase polypeptides of the fungi Humicola or Scytalidium, and in particular of the species Humicola insolens or Scytalidium thermophilum, can likewise be used within the scope of the invention.

It is particularly preferred according to the invention if the compositions according to the invention comprise at least one mannanase polypeptide from gram-positive alkalophilic Bacillus strains as the mannanase enzyme, in particular selected from at least one representative of the group consisting of Bacillus subtilis, Bacillus lentus, Bacillus clausii, Bacillus agaradhaerens, Bacillus brevis, Bacillus stearothermophilus, Bacillus alkalophilus, Bacillus amyloliquefaciens, Bacillus coagulans, Bacillus circulans, Bacillus lautus, Bacillus thuringiensis, Bacillus cheniformis, and Bacillus sp., and particularly preferably selected from at least one representative from the group consisting of Bacillus sp. 1633, Bacillus sp. AAII2, Bacillus clausii, Bacillus agaradhaerens and Bacillus licheniformis.

A preferred mannanase according to the invention is selected from at least one representative from the group consisting of
i) polypeptides comprising an amino acid sequence having at least 90% (increasingly preferably at least 90.5%, 91%, 91.5%, 92%, 92.5%, 93%, 93.5%, 94%, 94.5%, 95%, 95.5%, 96%, 96.5%, 97%, 97.5%, 98%, 98.5%, 99.0%, 99.1%, 99.2%, 99.3%, 99.4%, 99.5%, 99.6%, 99.7% or 99.8%) sequence identity with the polypeptide according to SEQ ID no. 1 (see sequence listing); and
ii) polypeptides that are a fragment of (i).
   It is, in turn, preferred if the described preferred mannanase is present in the compositions according to the invention in a total amount of 0.01 to 1.0 wt. %, and in particular of 0.02 to 0.1 wt. %, each based on the total weight of the composition.

It is particularly preferred if the liquid surfactant composition according to the invention also comprises at least one a-amylase, in addition to the preferred protease of the alkaline protease type from Bacillus lentus DSM 5483, or in addition to the protease that is sufficiently similar thereto (based on the sequence identity), comprising multiple of these modifications in combination.

Serving as an enzyme, a-amylases (EC 3.2.1.1) internally hydrolyze a-1,4-glycosidic bonds of starch and starch-like polymers. This a-amylase activity is measured in KNU (Kilo Novo Units) according to applications WO 9703160 A1 and GB 1296839, for example. 1 KNU is the amount of enzyme that hydrolyzes 5.25 g starch (available from Merck, Darmstadt, Germany) per hour at 37° C., pH 5.6 and in the presence of 0.0043 M calcium ions. An alternative activity determination method is known as the DNS method, which is described in the application WO 0210356 A2, for example. According to this method, the oligosaccharides, disaccharides and glucose units released by the enzyme during the hydrolysis of starch are detected by oxidation of the reducing ends using dinitrosalicylic acid (DNS). The activity is obtained in μmol of reducing sugar (based on maltose) per min and ml, yielding activity values in TAU. The same enzyme can be determined using a variety of methods, wherein the respective conversion factors can vary depending on the enzyme and thus must be established based on a standard. It is possible to approximately calculate that 1 KNU corresponds to approximately 50 TAU. Another activity determination method is the measurement using the Quick-Start® test kit from Abbott, Abbott Park, Ill., USA.

A preferred field of application according to the invention of the liquid surfactant compositions in according to the invention is the cleaning of textiles. Since washing and cleaning agents for textiles primarily have alkaline pH values, in particular a-amylases that are active in the alkaline environment are used for this purpose. These are produced by microorganisms, which is to say fungi or bacteria, and especially those of the Aspergillus and Bacillus genera, and secreted. Proceeding from these natural enzymes, furthermore a vast wealth of variants is available, which were derived by way of mutagenesis and, depending on the field of application, have specific advantages.

Examples of these include the a-amylases from Bacillus licheniformis, from B. amyloliquefaciens and from B. stearothermophilus, and the further developments thereof which have been improved for use in washing or cleaning agents. The enzyme from B. licheniformis is available from Novozymes by the name Termamyl®, and from Genencor by the name Purastar® ST. Further development products of this α-amylase are available from Novozymes under the trade names Duramyl® and Termamyl® ultra, from Genencor by the name Purastar® OxAm, and from Daiwa Seiko Inc., Tokyo, Japan, as Keistase®. The α-amylase from B. amyloliquefaciens is sold by Novozymes by the name BAN®, and derived variants of the α-amylase from B. stearothermophilus are available by the names BSG® and Novamyl®, likewise from Novozymes.

Examples of a-amylases from other organisms are the further developments of the a-amylase from Aspergillus niger and A. oryzae available from Novozymes under the trade name Fungamyl®. Another commercial product is the Amylase-LT®, for example.

The prior art includes, among other things, the three patent applications WO 9623873 A1, WO 0060060 A2 and WO 0166712 A2, which were filed by Novozymes. WO 9623873 A1 in part describes several different point mutations at a total of more than 30 different positions in four different wild-type amylases and claims those for all amylases that are at least 80% identical to one of these four; they are reported to exhibit changed enzymatic properties in terms of thermostability, oxidation stability, and calcium dependence. Application WO 0060060 A2 likewise describes a plurality of possible amino acid exchanges at 10 different positions on the a-amylases from two different microorganisms and claims those for all amylases showing homology of at least 96% identity. WO 0166712 A2, finally, describes 31 different amino acid positions, some of which are identical to those described above, which have been mutated in one of the two ca-amylases described in application WO 0060060060 A2.

WO 9623873 A1, for example, specifically describes the option of replacing an M at position 9 according to the numbering of AA560 with an L in the above-mentioned a-amylases, replacing M at position 202 with L, and deleting the amino acids located at positions 182 and 183 (or 183 and 184). WO 0060060 A2 specifically discloses, among other things, the amino acid variation N195X (which is to say, essentially with any other amino acid). WO 0166712 A2 discloses, among other things, the amino acid variations R118K, G186X (including, in particular, the exchange G186R, which is not relevant here), N299X (including, in particular the exchange N299A, which is not relevant here), R320K, E345R and R458K.

Especially particularly preferably, in addition to the preferred protease of the alkaline protease type from Bacillus lentus DSM 5483, or a protease that is sufficiently similar thereto (based on the sequence identity), the liquid surfactant composition according to the invention also comprises at least one a-amylase exhibiting a higher activity at temperatures between 10 and 20° C. than the amylase bearing the trade name “Stainzyme 12 L” from Novozymes.

Preferred compositions according to the invention comprise a-amylase in a total amount of 0.01 to 1.0 wt. %, in particular of 0.02 to 0.1 wt. %.

It is preferred according to the invention if the liquid surfactant composition additionally comprises at least one polyalkoxylated polyamine.

The polyalkoxylated polyamine within the scope of the present invention and the individual aspects thereof is a polymer having an N atom-containing backbone, which carries polyalkoxy groups at the N atoms. The polyamine comprises primary amino functions at the ends (terminus and/or side chains), and inside preferably comprises both secondary and tertiary amino functions; optionally, it may also comprise only secondary amino functions inside, whereby the polyamine obtained is not branched-chain, but linear. The ratio of primary to secondary amino groups in the polyamine is preferably in the range of 1:0.5 to 1:1.5, and in particular in the range of 1:0.7 to 1:1. The ratio of primary to tertiary amino groups in the polyamine is preferably in the range of 1:0.2 to 1:1, and in particular in the range of 1:0.5 to 1:0.8. The polyamine preferably has an average molar mass in the range of 500 g/mol to 50,000 g/mol, and in particular of 550 g/mol to 5000 g/mol. The N atoms in the polyamine are separated from one another by alkylene groups, preferably by alkylene groups having 2 to 12 carbon atoms, and in particular 2 to 6 carbon atoms, wherein not all alkylene groups must have the same number of carbon atoms. Ethylene groups, 1,2-propylene groups, 1,3-propylene groups and the mixtures thereof are particularly preferred. Polyamines carrying ethylene groups as the described alkylene group are also referred to as polyethylenimine or PEI. PEI is a particularly preferred polymer according to the invention having an N atom-containing backbone.

The primary amino functions in the polyamine can carry 1 or 2 polyalkoxy groups, and the secondary amino functions can carry 1 polyalkoxy group, wherein not every amino function must be substituted with alkoxy groups. The average number of alkoxy groups per primary and secondary amino function in the polyalkoxylated polyamine is preferably 1 to 100, and in particular 5 to 50. The alkoxy groups in the polyalkoxylated polyamine are preferably polypropoxy groups, which are bound directly to N atoms, and/or polyethoxy groups, which are bound to possibly present propoxy radicals and to N atoms carrying no propoxy groups.

Polyethoxylated polyamines are obtained by reacting polyamines with ethylene oxide (abbreviated as, EO). The polyalkoxylated polyamines that comprise ethoxy and propoxy groups are preferably accessible by reacting polyamines with propylene oxide (abbreviated as, PO) and subsequent reaction with ethylene oxide.

The average number of propoxy groups per primary and secondary amino function in the polyalkoxylated polyamine is preferably 1 to 40, and in particular 5 to 20.

The average number of ethoxy groups per primary and secondary amino function in the polyalkoxylated polyamine is preferably 10 to 60, and in particular 15 to 30.

If desired, the terminal OH function polyalkoxy substituents in the polyalkoxylated polyamine can be partially or fully etherified with a C₁ to C₁₀, and in particular C₁ to C₃, alkyl group.

Particularly preferred polyalkoxylated polaymines according to the invention can be selected from polyamine reacted with 45 EO per primary and secondary amino function, PEIs reacted with 43 EO per primary and secondary amino function, PEIs reacted with 15 EO+5 PO per primary and secondary amino function, PEIs reacted with 15 PO+30 PO per primary and secondary amino function, PEIs reacted with 5 PO 4+39.5 EO per primary and secondary amino function, PEIs reacted with 5 PO+15 EO per primary and secondary amino function, PEIs reacted with 10 PO+35 EO per primary and secondary amino function, PEIs reacted with 15 PO+30 EO per primary and secondary amino function, and PEIs reacted with 15 PO+5 EO per primary and secondary amino function. An especially particularly preferred alkoxylated polyamine is PEI having a content of 10 to 20 nitrogen atoms reacted with 20 units EO per primary or secondary amino function of the polyamine.

A furthermore preferred subject matter of the invention is the use of polyalkoxylated polyamines, which can be obtained by reacting polyamines with ethylene oxide, and optionally additionally propylene oxide. If polyamines polyalkoxylated with ethylene oxide and propylene oxide are used, the content of propylene oxide in the total amount of the alkylene oxide is preferably 2 mol % to 18 mol %, and in particular 8 mol % to 15 mol %.

The liquid composition, based on the total weight thereof, preferably comprises polyalkoxylated polyamines in a total amount of 0.1 to 10 wt. %, and in particular of 0.5 to 5.0 wt. %.

In addition to the ingredients according to the invention, the liquid surfactant compositions according to the invention can comprise further ingredients, which further improve the application-related and/or aesthetic properties of the washing agent. Within the scope of the present invention, the composition according to the invention preferably additionally comprises one or more substances from the group consisting of bleaching agents, complexing agents, builders, electrolytes, pH-setting agents, perfumes, perfume carriers, fluorescent agents, dyes, hydrotopics, foam inhibitors, silicone oils, polymeric thickeners, anti-redeposition agents, shrinkage preventers, anti-wrinkle agents, color transfer inhibitors, antimicrobial active agents, germicides, fungicides, antioxidants, preservatives, corrosion inhibitors, antistatic agents, bittering agents, ironing aids, repellents and impregnating agents, swelling and anti-slip agents, softening components, and UV absorbers.

According to the invention, a polymeric thickener shall be understood to mean a polymeric compound that has an average molar mass (average molecular weight M_{w}) of more than 1500 g/mol and increases the viscosity of the composition according to the invention when used in an amount of 0.1 wt. %. According to the invention, in particular polyacrylates are considered polymeric thickeners. The polyacrylates include polyacrylate or polymethacrylate thickeners, such as the high molecular weight homopolymers of acrylic acid cross-linked with a polyalkenyl polyether, and in particular an allyl ether of sucrose, pentaerythrite or propylene (INCI name according to “International Dictionary of Cosmetic Ingredients” of “The Cosmetic, Toiletry and Fragrance Association (CTFA)”: Carbomer), which are also referred to as carboxyvinyl polymers. Such polyacrylic acids are available, among other things from 3V Sigma under the trade name Polygel®, and from Noveon under the trade name Carbopol®, such as Carbopol 940 (molecular weight approximately 4,000,000), Carbopol 941 (molecular weight approximately 1,250,000) or Carbopol 934 (molecular weight approximately 3,000,000). Furthermore, this includes the following acrylic acid copolymers: (i) copolymers of two or more monomers from the group of the acrylic acid, methacrylic acid and the simple esters thereof, preferably formed with C₁₋₄ alkanols (INCI Acrylates Copolymer), which include, for example, the copolymers of methacrylic acid, butyl acrylate and methyl methacrylate (CAS number according to Chemical Abstracts Service: 25035-69-2) or of butyl acrylate and methyl methacrylate (CAS 25852-37-3) and which are available, for example, from Rohm & Haas under the trade names Aculyn® and Acusol®, and from Degussa (Goldschmidt) under the trade name Tego® Polymer, for example the anionic non-associative polymers Aculyn 22, Aculyn 28, Aculyn 33 (cross-linked), Acusol 810, Acusol 823 and Acusol 830 (CAS 25852-37-3); (ii) cross-linked high molecular weight acrylic acid copolymers, which include, for example, the copolymers of C₁₀₋₃₀ alkyl acrylates with one or more monomers from the group of the acrylic acid, methacrylic acid and the simple esters thereof, preferably formed with C₁₋₄ alkanols (FNCI Acrylates/C10-30 Alkyl Acrylate Crosspolymer), which are cross-linked with an allyl ether of sucrose or of pentaerythrite and which are available, for example, from Noveon under the trade name Carbopol®, such as the hydrophobized Carbopol ETD 2623 and Carbopol 1382 (INCI Acrylates/C 10-30 Alkyl Acrylate Crosspolymer) and Carbopol Aqua 30 (formerly Carbopol EX 473).

It is preferred according to the invention if the liquid composition comprises polymeric thickeners in a total amount of 0 to 0.1 wt. %, in particular of 0 to 0.05 wt. %, and especially preferably of 0 to 0.01 wt. %, based on the total weight of the composition. It is especially particularly preferred if the composition is free of polymeric thickeners.

All substances that destroy or absorb dyes by way of oxidation, reduction or adsorption and thereby remove color from materials may be used as bleaching agents. These include, among other things, hypohalogenite-containing bleaching agents, hydrogen peroxide, perborate, percarbonate, peracetic acid, diperoxyazelaic acid, diperoxododecanedioic acid, and oxidative enzyme systems.

In particular silicates, aluminum silicates (in particular zeolites), carbonates, salts of organic dicarboxylic and polycarboxylic acids, and mixtures of these substances, shall be mentioned as builders that may be present in the composition according to the invention.

Organic builders that may be present in the composition according to the invention are, for example, the polycarboxylic acids that can be used in the form of the sodium salts thereof, wherein polycarboxylic acids shall be understood to mean those carboxylic acids which carry more than one acid function. These include, for example, citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acids such as citric acid, adipic acid, succinic acid, glutaric acid, tartaric acid, saccharic acids, and mixtures thereof.

Moreover, polymeric polycarboxylates are suitable builders. These are, for example, the alkali metal salts of polyacrylic acid or of polymethacrylic acid, for example those having a relative molar mass from 600 to 750,000 g/mol.

Suitable polymers are in particular polyacrylates, which preferably have a molar mass from 1,000 to 15,000 g/mol. Due to the superior solubility thereof short-chain polyacrylates having molar masses from 1,000 to 10,000 g/mol, and particularly preferably from 1,000 to 5,000 g/mol, may in turn be preferred from this group.

Also suitable are copolymeric polycarboxylates, in particular those of acrylic acid with methacrylic acid, and of acrylic acid or methacrylic acid with maleic acid. To improve the water solubility, the polymers can also contain allyl sulfonic acids, such as allyloxybenzene sulfonic acid and methallyl sulfonic acid, as a monomer.

Soluble builders, such as citric acid, or acrylic polymers having a molar mass of 1,000 to 5,000 g/mol are preferred in liquid compositions according to the invention.

A second subject matter of the invention is the use of a liquid surfactant composition of the first subject matter of the invention in a method for washing textiles.

A third subject matter of the invention is a method for washing textiles, comprising the provision of a washing liquor by
(i) dosing a liquid surfactant composition of the first subject matter of the invention;
(ii) mixing this dose in at least one solvent, in particular water; and
(iii) bringing the resulting mixture in contact with at least one textile.

According to the invention, a washing liquor is at least the total amount of the components used in (i) and (iii).

Methods for cleaning textiles are generally characterized in that, in multiple method steps, different substances providing cleaning action are applied to the product to be cleaned and washed off following the residence time, or that the product to be cleaned is treated in another manner with a composition of the first subject matter of the invention or a solution of this composition. It is preferred according to the invention if, within the scope of a pretreatment of textiles, at least a portion of the described liquid composition is initially applied directly to select soiled areas of the textile, and subsequently, following a residence time (of preferably 30 to 300 seconds), the at least one solvent from step (ii), the remainder of the textiles from step (iii), and optionally the remainder of the described liquid composition are combined, while providing a washing liquor.

When the at least one solvent of the method according to the invention is added to the washing liquor, it is preferred according to the invention to combine one part by volume of the described liquid composition with 5 to 3000 parts by volume of the at least one solvent.

### EXAMPLES

The following liquid washing agent composition was produced by mixing:

| Ingredient | Amount in wt. % | Amount in wt. % |
|---|---|---|
| C₁₂₋₁₈ fatty alcohol ether | 14.70 | 14.70 |
| sulfate with 2 moles | | |
| ethylene oxide | | |
| C₁₂₋₁₈ fatty alcohol ether | 3.00 | 3.00 |
| sulfate with 7 moles | | |
| ethylene oxide | | |
| C₁₂₋₁₈ fatty alcohol ether | 5.00 | 5.00 |
| with 7 moles ethylene | | |
| oxide | | |
| C₁₀₋₁₃ alkybenzene | 4.20 | 4.20 |
| sulfonate sodium | | |
| Soidum hydroxide | 2.00 | 2.00 |
| Boric acid | 1.50 | 1.50 |
| Citric acid mononhydrate | 2.90 | 2.90 |
| Diethylene triamine | 1.00 | — |
| penta(methylene phosponic | | |
| acid) hepta sodium salt | | |
| EDTA | — | 1.00 |
| Ethylene diamine-N,N′- | 1.00 | 1.00 |
| disuccinic acid tri-sodium | | |
| salt | | |
| Sodium formiate | 0.30 | 0.30 |
| Coconut fatty acid | 2.00 | 2.00 |
| alkoxylated polyamine | 2.00 | 2.00 |
| made of PEI having a | | |
| content of 10 to 20 nitrogen | | |
| atoms reacted with 20 units | | |
| of ethylene oxide per | | |
| primary or secondary | | |
| amino function of the | | |
| polyamine | | |
| 1,2-propanediol | 2.00 | 2.00 |
| Ethanol | 1.00 | 1.00 |
| Dyes, defoaming agents, | 0.15 | 0.15 |
| optical brighteners | | |
| Protease according to SEQ | 1.50 | 1.50 |
| ID NO 2 | | |
| α-amylase | 0.50 | 0.50 |
| Mannanase | 0.30 | 0.30 |
| Cellulase | 0.20 | 0.20 |
| Perfume | 1.30 | 1.30 |
| Water | to make up to 100 | to make up to 100 |

The washing agents exhibited acceptable rheology, were storage-stable (no phase separation or turbidity), and the protease had a high activity even after storage.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid surfactant composition, comprising, based on the total weight of the composition,
a) C₉-C₂₀ alkylbenzene sulfonate in an amount of 2.0 to 8.5 wt. %; and
b) R¹—O—(CH₂CH₂O)ₙ—SO₃M in an amount of 10.0 to 18.0 wt. %,
wherein R¹ denotes a C₁₂₋₁₈ alkyl group, n denotes a number from 2 to 3, and M denotes a univalent cation; and
c) R²—O—(CH₂CH₂O)ₘ—SO₃M′ in an amount of 1.0 to 6.0 wt. %,
wherein R² denotes a C₁₂-8 alkyl group, m denotes a number from 7 to 8, and M′ denotes a univalent cation;
d) a non-ionic surfactant in an amount of 2.0 to 10.0 wt. %;
e) water; and
f) at least one enzyme.

2. The liquid surfactant composition according to claim 1, wherein the C₉-C₂₀ alkylbenzene sulfonate is C₁₀-C₁₅ alkylbenzene sulfonate.

3. The liquid surfactant composition according to claim 1, wherein the C₉-C₂₀ alkylbenzene sulfonates are one or more compounds of formula (a) 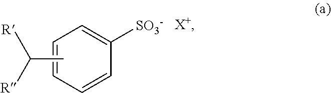
wherein R′ and R″ together have 8 to 19, carbon atoms, and X⁺ denotes a univalent cation.

4. The liquid surfactant composition according to claim 1, wherein X⁺ cation is Na⁺, K⁺, HO—CH₂CH₂NH₃⁺, (HO—CH₂CH₂)₃NH⁺.

5. The liquid surfactant composition according to claim 1, wherein n is 2.

6. The liquid surfactant composition according to claim 1, wherein M is Na⁺.

7. The liquid surfactant composition according to claim 1, wherein m is 7.

8. The liquid surfactant composition according to claim 1, wherein M′ is Na⁺.

9. The liquid surfactant composition according to claim 1, wherein the non-ionic surfactant is fatty alcohol ethoxylate(s) in an amount of 2.0 to 10 wt. %.

10. The liquid surfactant composition according to claim 1, wherein the at least one enzyme present comprises a protease.

11. The liquid surfactant composition according to claim 1, wherein the at least enzyme is a protease of the alkaline protease type from Bacillus lentus DSM 5483, or a protease that is sufficiently similar thereto based on the sequence identity and comprises several of these modifications in combination.

12. The liquid surfactant composition according to claim 1, wherein the at least one enzyme is a protease comprising an amino acid sequence that is at least 70% identical to the amino acid sequence indicated in SEQ ID NO. 1 over the entire length thereof and comprises the amino acid substitution R99E or R99D, using the numbering according to SEQ ID NO. 1, in combination with at least two further amino acid substitutions, which are selected from the group consisting of S3T, V4I, and V199I.

13. The liquid surfactant composition according to claim 1, wherein the at least enzyme comprises a protease comprising an amino acid sequence that is at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, and 98.5% identical to the amino acid sequence indicated in SEQ ID NO. 1 over the entire length thereof and has the amino acid substitution R99E, using the numbering according to SEQ ID NO. 1, in combination with the amino acid substitutions S3T, V4I and V199I, and in particular a protease according to SEQ ID NO. I comprising the amino acid substitutions S3T, V4I, R99E and V199I.

14. The liquid surfactant composition according to claim 1, wherein the weight ratio of the C₉-C₂₀ alkylbenzene sulfonate of component a) to the R¹—O—(CH₂CH₂O)ₙ—SO₃M of component b) is 1:9 to 1:2.

15. The liquid surfactant composition according to claim 1, wherein the weight ratio of the C₉-C₂₀ alkylbenzene sulfonate of component a) to the R²—O—(CH₂CH₂O)ₘ—SO₃M′ of component c) is 2:1 to 1:2.

16. The liquid surfactant composition according to claim 1, wherein the weight ratio of the C₉-C₂₀ alkylbenzene sulfonate of component a) to the non-ionic surfactant of component d) is 2:1 to 1:5.
